(19) United States
(12) Patent Application Publication
(10) Pub. No.: US 2013/0000295 A1
(43) Pub. Date: Jan. 3, 2013

(54) VEHICLE WITH PRIMARY AND SECONDARY AIR SYSTEM CONTROL FOR ELECTRIC POWER TAKE OFF CAPABILITY

(75) Inventor: Jay E. Bissontz, Fort Wayne, IN (US)

(73) Assignee: International Truck Intellectual Property Company, LLC, Lisle, IL (US)

(21) Appl. No.: 13/634,478

(22) PCT Filed: Mar. 16, 2010
(86) PCT No.: PCT/US10/27415

§ 371 Date: Sep. 12, 2012

(51) Int. Cl. F15B 21/08

(52) U.S. Cl. 60/409

(57) ABSTRACT

Operation of selected pneumatic components on an electric hybrid truck is suspended during operation of electrical power take off applications installed on the truck. By suspending operation of the air suspension periods of operation of the truck's thermal engine to support the truck's air compressor system are reduced sparing fuel.

### BACKGROUND

1. Technical Field

The technical field relates to control of vehicle pneumatic systems, particularly where used on electric hybrid vehicles equipped for electrical power take-off (PTO) operations.

2. Description of the Problem

Hybrid vehicles are generally equipped with at least two prime movers capable of developing mechanical power. One prime mover can be a thermal engine such as an internal combustion engine, although it is conceivable that the vehicle could be equipped with a gas turbine or a steam engine. This engine generates mechanical power from the combustion of a hydro-carbon fuel. The second prime mover frequently is a dual function system that can either develop mechanical work or can convert applied mechanical work to a form which can be stored. One source of mechanical work subject to conversion for storage can be vehicle kinetic energy captured during braking (regenerative braking) Another source can be the thermal engine being operated to supply mechanical work to the second prime mover.

Electric traction motors can readily function in the role of the second prime mover. Electric traction motors use electricity sourced from batteries or capacitors to provide mechanical work. They can be back driven from a vehicle's drive wheels or from the first prime mover to generate electricity for storage in the batteries or on the capacitors.

In a parallel type hybrid vehicle using an internal combustion engine (such as a diesel engine) and an electric traction motor as prime movers, either prime mover may be used to propel the vehicle and either may be connected to drive a power take off (PTO) application such as a hydraulic pump. Use of the electric traction motor to power the PTO application is often termed electric PTO or ePTO. The power consumption of many PTO applications is relatively low and intermittent compared to power consumption from moving the vehicle. Electric traction motor support of PTO applications spares operation of the internal combustion engine under conditions where lengthy periods of operation of the engine at or just above idle may occur. Since an electric traction motor does not have an “idle” operational state and since its efficiency is far less variable with operational speed than an internal combustion engine it conserves energy to use the traction motor as against using the internal combustion engine to support PTO. The internal combustion engine may be operated sporadically to maintain the charge on the vehicle's batteries during ePTO, but is otherwise off.

The ePTO mode of operation can be used with truck equipment manufacture (TEM) installed devices such as a hydraulic pump for the purpose of operating truck mounted hydraulic motion equipment. It is a common practice with PTO applications to use a pneumatically actuated, internal coupling device consisting of a clutch pack or sliding spline/gear set which in turn ties either primary mover to the load(s) (e.g., a hydraulic pump) mated to the output shaft of the PTO application. This aspect of the application does not change between PTO supported by the internal combustion engine and ePTO. The pneumatic system is supported by an air compressor which may be coupled directly to the internal combustion engine for operation.

Hybrid electric vehicles configured with pneumatically actuated PTO coupling devices may also be equipped with other pneumatic systems. One example of another pneumatic system is an air suspension system. In an air suspension air bags/springs carry a portion of the vehicle's weight, typically at each wheel. Air suspension systems often provide for automatic leveling of the vehicle. When a vehicle equipped for automatic leveling is in the ePTO mode of operation (thermal diesel engine not running), the chassis' position and loading in relation to a suspension level sensor system can change. Outriggers may be deployed changing the local loading on the individual air springs. Even without outriggers the load carried by each wheel of the vehicle can be affected by use of the PTO application such as a aerial lift unit which can be rotated or extended. Under these circumstances the level sensor system can cause the air suspension system to inflate and deflate suspension air springs in an attempt to level the vehicle. However, in trying to level the vehicle, the air suspension leveling system can deplete the vehicle's supply of compressed air, which also supplies the pneumatically actuated PTO mechanism.

Under non-hybrid ePTO applications this inflation and deflation process is of little consequence because the thermal diesel engine is running and typically provides ample surplus power at near idle operation to turn the chassis' air compressor and thereby maintain sufficient air pressure and volume for proper suspension and PTO operation. However, in the case of the hybrid ePTO mode of operation, once the primary air pressure begins to decline below a certain target set point (for example: 95 psi), the diesel engine will be automatically started and run in an attempt to regenerate the lost primary air pressure exhausted during the suspension leveling process. This loss of primary air pressure can now result in internal combustion engine operation and its consequent fuel consumption, compromising the energy gains from ePTO operation. Additionally, if the primary air pressure declines far enough (for example: 90 psi), the pneumatically actuated PTO coupling mechanism can disengage causing the hydraulic motion control equipment to become inoperable until such time that the engine run cycle has had the opportunity to regenerate sufficient air pressure necessary to once again support ePTO operation.

Other pneumatic systems can be present on vehicles including central tire inflation systems, pneumatically actuated windshield wipers, pneumatic tool circuits, air brakes and the like. Similarly the operation of these systems can deplete the compressed air charge stored on the vehicle affecting the operation of the pneumatically actuated spline for the PTO application.

### SUMMARY

A hybrid vehicle having an internal combustion engine, an electric traction motor and a power take off application selectively operable from the internal combustion engine or the electric traction motor includes a pneumatic system operated from storage tanks and a compressor operated off the internal combustion engine. The vehicle includes pneumatic components which are connected to be charged by the pneumatic system. The power take off application uses a pneumatically actuated connector to provide selective operation of the power take off application from the internal combustion engine or the electric traction motor.

Operation of the pneumatic supply and pneumatic utilization systems on a hybrid vehicle are coordinated with the type of ePTO modes of operation. The pneumatically actuated spline or connector in effect has a priority claim on available stored air. For some pneumatic system this may involve the temporary termination of operation for a particular pneumatic system/application. For example, air pressure from a pneumatic suspension system may be dumped and operation of the pneumatic suspension system suspended. Similarly a pneumatic windshield wiper or central inflation system may be turned off if ePTO occurs with the vehicle stationary. A pneumatic tool circuit may be allowed to operate depending upon the likelihood that a particular tool will be needed during ePTO operation entailing normal responsive operation of the thermal engine to run the pneumatic supply system to supplement available stored air in response to declining air pressure.

### BRIEF DESCRIPTION OF THE DRAWINGS

FIG. 1 is a side view of hybrid-electric vehicle carrying a power take-off operation.

FIG. 2 is a high level schematic of a vehicle drive train and vehicle control system for a hybrid-electric vehicle.

### DETAILED DESCRIPTION

In the following detailed description example sizes/models/values/ranges may be given with respect to specific embodiments but are not to be considered generally limiting.

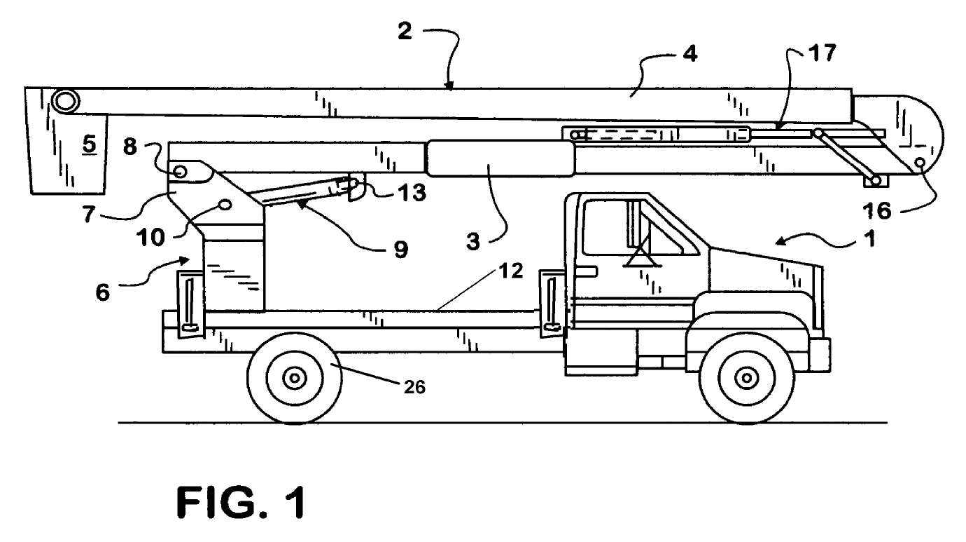

Referring now to the figures and in particular to FIG. 1, a hybrid mobile aerial lift truck 1 is illustrated. Hybrid mobile aerial lift truck 1 serves as an example of a medium duty vehicle which supports a PTO application of which a hydraulically operated aerial lift unit 2 mounted on a truck bed 12 serves as an example. Movement of the aerial lift unit 2, including raising it, lowering it, extending or retracting it, or rotating it can result in an apparent shifting of the load carried by the hybrid mobile aerial lift truck 1. This can further result in a change in the level of the vehicle absent compensation. Other PTO applications which can affect the level of a vehicle include applications such as outriggers and augers.

The aerial lift unit 2 includes a lower boom 3 and an upper boom 4 pivotally interconnected to each other. The lower boom 3 is in turn mounted to rotate on the truck bed 12 on a support 6 and rotatable support bracket 7. The rotatable support bracket 7 includes a pivoting mount 8 for one end of lower boom 3. A bucket 5 is secured to the free end of upper boom 4 and supports personnel during lifting of the bucket to and support of the bucket within a work area. Bucket 5 is pivotally attached to the free end of boom 4 to maintain a horizontal orientation at all times. A hydraulic lifting unit 9 is interconnected between rotatable support bracket 7 and the lower boom 3 by pivot connection 10 to the rotatable support bracket 7 pivot 13 on the lower boom 3. Hydraulic lifting unit 9 is connected to a pressurized supply of a suitable hydraulic fluid, which allows the assembly to be lifted, lowered and rotated. Any of these movements have the potential for affecting the level of the hybrid mobile aerial lift truck 1.

The outer end of the lower boom 3 is interconnected to the lower and pivot end of the upper boom 4. A pivot 16 interconnects the outer end of the lower boom 3 to the pivot end of the upper boom 4. An upper boom compensating assembly 17 is connected between the lower boom 3 and the upper boom 4 for moving the upper boom about pivot 16 to position the upper boom relative to the lower boom 3. The upper-boom compensating assembly 17 allows independent movement of the upper boom 4 relative to lower boom 3 and provides compensating motion between the booms to raise the upper boom with the lower boom. Upper boom compensating assembly 17 is usually supplied with pressurized hydraulic fluid from the same sources as hydraulic lifting unit 9. Outrigger struts 96 may be installed at the corners of the truck bed 12 to stabilize when positioned on uneven terrain.

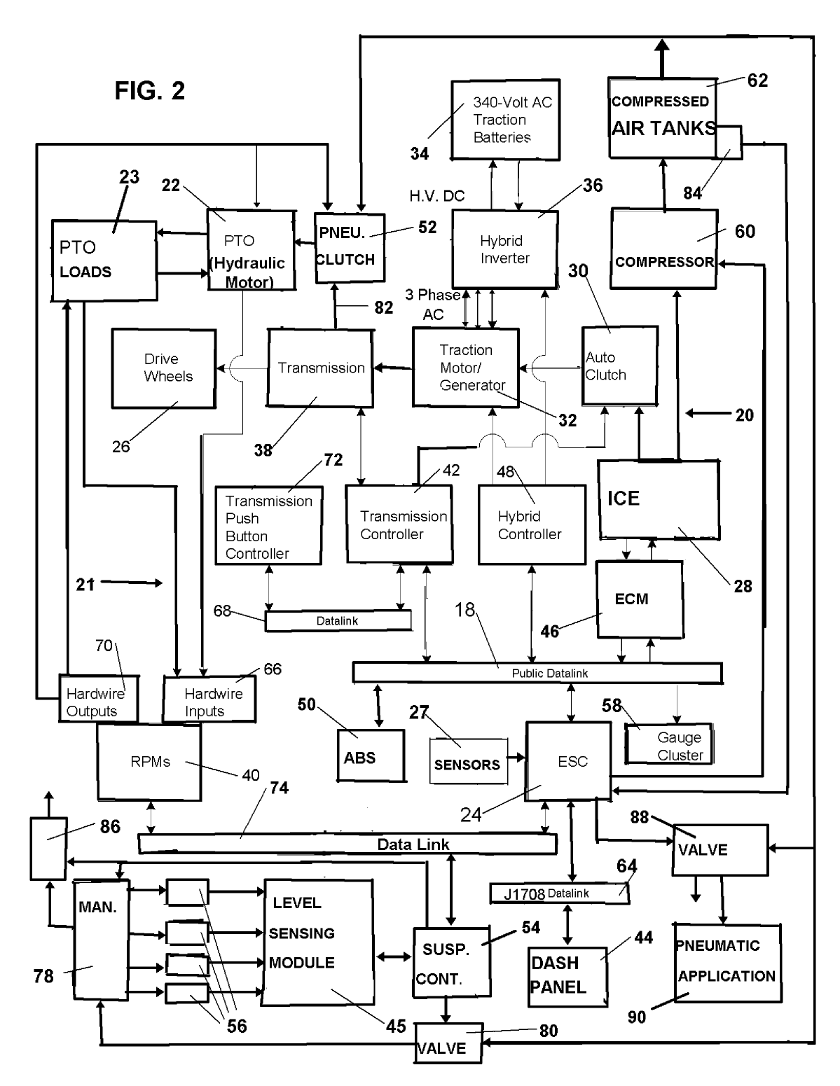

A common source of pressurized hydraulic fluid is a PTO device (a hydraulic pump) 22. The hydraulic pump 22 may be powered by either of two prime movers installed on hybrid mobile aerial lift truck 1. The prime movers are typically an internal combustion engine 28 and an electric traction motor 32 (See FIG. 2).

Referring to FIG. 2, a high level schematic of a control system 21 which provides control over a hybrid drive train 20 such as may be used on hybrid mobile aerial lift truck 1 is illustrated. An electrical system controller (ESC) 24, a type of a body computer, operates as a system supervisor and is linked by a Society of Automotive Engineers (SAE) J1939 standard compliant public data link 18 to a variety of local controllers. These local controllers in turn implement direct control over many vehicle functions not directly controlled by the ESC 24. As may be inferred, ESC 24 is typically directly connected to selected inputs (including ESC sensors package 27) and outputs (such as headlamp switches (not shown)). ESC 24 communicates with a dash panel 44 from which it may obtain signals indicating headlamp on/off switch position and provide on/off signals to other items, such as dash instruments (not shown). Ignition position may be included among the signals included in the ESC sensors package 27, which are directly connected to input ports of the ESC 24. Signals relating to activating a power take-off (PTO) application, and to changing the output level of the prime mover engaged to support PTO, may be generated from a number of sources, including dash panel 44 and hardwire inputs 66 to remote power module (RPM) 40. These signals may be communicated to ESC 24 or to the engine controller (ECM) 46 directly or over one of the vehicle data links, such as a SAE J1708 compliant data link 64 for dash panel 44 or a private SAE J1939 compliant data link 74 for RPM hardwire inputs 66. SAE J1708 compliant data links exhibit a low baud rate data connection, typically about 9.7K baud and are typically used for transmission of on/off switch states. Private SAE J1939 compliant data links usually exhibit higher data transmission rates than public SAE J1939 compliant data links.

Five controllers in addition to the ESC 24 are illustrated as being connected to the public data link 18. These controllers include an engine controller 46, a transmission controller 42, a hybrid controller 48, a gauge cluster controller 58 and an anti-lock brake system controller (ABS) 50. It will be understood that other controllers may be installed on the vehicle in communication with data link 18. Various sensors may be connected to several of the local controllers. Data link 18 is preferably the bus for a public controller area network (CAN) conforming to the SAE J1939 standard which under current practice supports data transmission at up to 250K baud.

Hybrid controller 48, transmission controller 42 and engine controller 46 coordinate operations of the hybrid drive train 20 to select between the internal combustion engine (ICE) 28 and the traction motor 32 as the prime mover for the vehicle (or possibly to combine the output of the engine and the traction motor). During vehicle braking these same controllers can operate to coordinate disengagement of the auto clutch 30, potentially shutting down internal combustion engine 28 and engaging operation of traction motor 32 in its generation mode to recapture some of the vehicle's kinetic energy by back driving the traction motor 32 to generate electricity. The ESC 24 and the ABS controller 50 provide data over data link 18 used for these operations, including brake pedal position, data relating to skidding, throttle position and other power demands such as for PTO device 22. The hybrid controller further monitors a proxy relating to traction battery 34 state of charge (SOC).

Hybrid drive train 20 is illustrated as a parallel hybrid diesel electric system in which the traction motor/generator 32 is connected in line with an internal combustion engine 28 through an auto-clutch 30 so that the internal combustion engine 28 or the traction motor 32 can function as the vehicle's prime mover. In a parallel hybrid-electric vehicle the traction motor/generator 32 is used to recapture vehicle kinetic energy during deceleration by using the drive wheels 26 to back drive the traction motor/generator 32 thereby applying a portion of the vehicle's kinetic energy to the generation of electricity. The generated electricity is converted from three phase AC by the hybrid inverter 36 and applied to traction battery 34 as direct current power. The system functions to recapture a vehicle's inertial momentum during braking and convert and store the recaptured energy as potential energy for later use, including reinsertion into the hybrid drive train 20. Internal combustion engine 28 is disengaged from the other components in hybrid drive train 20 by opening auto-clutch 30 during periods when the traction motor/generator 32 is back driven.

Transitions between positive and negative traction motor 32 electrical power consumption are detected and managed by a hybrid controller 48. Traction motor/generator 32, during braking, generates three phase alternating current which is applied to a hybrid inverter 36 for conversion to direct current (DC) for application to traction battery 34. When the traction motor 32 is used as a vehicle prime mover the flow of power is reversed.

High mass vehicles tend to exhibit smaller gains in energy conservation from hybrid locomotion than do automobiles. Thus electrical power available from traction battery 34 is often used to power other vehicle systems such as a PTO device 22, which may be a hydraulic motor, by supplying electrical power to the traction motor 32 which in turn provides the motive force or mechanical power used to operate the PTO device 22. The intermittent or low power requirements of the PTO device 22 may make its operation using the internal combustion engine 28 highly inefficient since the ICE 28 would be operating much of the time at idle due to intermittent demands for power or at relatively low and inefficient power levels because the PTO device can absorb only a few watts of power. Thus a vehicle such as a hybrid mobile aerial lift truck 1 may be configured to intermittently start and run the internal combustion engine 28 at an efficient power output level in order to maintain traction battery 34 state of charge. This can occur during ePTO interrupting ePTO for conventional PTO. Traction motor/generator 32 may be used for starting internal combustion engine 28.

The various local controllers may be programmed to respond to data from ESC 24 passed to data link 18. Hybrid controller 48 determines, based on available battery charge state, requests for power. Hybrid controller 48 with ESC 24 generates the appropriate signals for application to data link 18 for instructing the engine controller 46 to turn internal combustion engine 28 on and off and, if on, at what power output to operate the engine. Transmission controller 42 controls engagement of auto clutch 30. Transmission controller 42 further controls the state of transmission 38 in response to transmission push button controller 72, determining the gear the transmission is in or if the transmission is to deliver drive torque to the drive wheels 26, to a pneumatic clutch 52, or if the transmission is to be in neutral.

Pneumatic clutch 52 provides engagement and disengagement between the transmission 38 and the PTO device 22 by a PTO shaft 82. Control over pneumatic clutch 52, PTO device 22 and PTO loads 23 is implemented through one or more remote power modules (RPM) 40. RPM 40 is data linked expansion input/output modules dedicated to the ESC 24, which is programmed to utilize them. An RPM 40 functions as the controller for PTO device 22 and pneumatic clutch 52, and provides any RPM hardwire outputs 70 and RPM hardwire inputs 66 associated with solenoid controlled valves and pressure sensors for the PTO device 22, PTO loads 23 and pneumatic clutch 52. Position sensors and the like may also be provided for the PTO device 22 and PTO loads 23. Requests for operation of PTO loads 23 and, potentially, response reports are applied to the data link 74 for transmission to the ESC 24, which formats the request for receipt by specific controllers or as reports. ESC 24 is also programmed to control valve states through the first RPM 40 in PTO device 22. Remote power modules are more fully described in U.S. Pat. No. 6,272,402 which is assigned to the assignee of the present invention and is fully incorporated herein by reference and wherein “Remote Power Modules” are referred to as “Remote Interface Modules”.

Pneumatic clutch 52 may be selectively supplied with compressed air from a compressed air storage system which is illustrated here as a compressed air tank 62. Those skilled in the art will recognize that on vehicles using air brakes such compressed air systems will include at least two tanks The compressed air tank 62 can also be connected to supply air to other pneumatic systems, such as air springs 56 through manifold solenoid valve assembly (MSVA) 78, or central tire inflation systems, pneumatic windshield wipers, pneumatic tools, etc. (which are represented generally as pneumatic applications 90) through a second MSVA 88. Compressed air tank 62 is supplied with compressed air by an air compressor 60. Air compressor 60 is usually physically coupled to the internal combustion engine 28 for operation. In a hybrid drive train 20 the internal combustion engine 28 may be engaged in compressed air tank 62 pressure falls below preselected minimums, as sensed by air pressure sensor 84 and the vehicle ignition is on as determined by the ESC 24 from ESC sensors package 27. ESC 24 may be provided with an output to control engagement and disengagement of air compressor 60 to ICE 28 by an integral clutch or to reduce the load which air compressor 60 imposes on ICE 28 by venting its output to the atmosphere when compressed air tank 62 is charged. Commonly the compressed air tank 62 is charged to a level above the trigger level which triggers charging of the air tank. A manifold valve

The control interaction of PTO and pneumatic systems other than pneumatic clutch 52 varies depending upon whether a vehicle is in the electrical PTO mode or not. If it is not, ICE 28 power is available to run compressor 60 and usually readily maintain minimum pressure levels in the compressed air tank 62. However, for a vehicle where ePTO mode has priority over conventional PTO to conserve ICE 28 fuel, avoidance of operation of ICE 28 is a priority.

One facet of interaction of the control regimens for a pneumatic system and PTO is exemplified by consideration of the hybrid mobile aerial lift truck 1. Vehicle level is adjustable at each wheel by changing the pressure in air springs 56, either by adding air to the air springs 56 or by releasing air from the air springs 56. Addition and release of air from the air springs 56 occurs through valves in manifold 78. Compressed air is available to the manifold 78 from compressed air tank 62. Air from the air springs 56 may be released to the atmosphere.

A suspension controller 54, which may communicate with the ESC 24 over private data link 74, provides control over valves in manifold 78 which allow addition or release of air from air springs 56. Level sensing module 45 may operate by seeking to match the extensions of each air spring 56 to a norm and will supply data to suspension controller 54 as to which of air springs 56 are under extended and which are overextended.

Demands for compressed air from compressed air tank 62 may be reduced during operation of PTO loads 23 by coordinating the ON/OFF state of the air springs 56 dump feature with engagement and disengagement of ePTO modes of operation. For example during ePTO implementation of body equipment movements such as rotation of the aerial lift unit 2, which are capable of affecting the ride high and, or level of the vehicle chassis in relationship to the suspension level sensing module 45, compressed air is not supplied to the air springs 56. Whether to allow operation of a given pneumatic devices 90 may be made on a case by case basis and may depend upon what the PTO loads 23 are. For example, pneumatic devices 90 can include pneumatic windshield wipers 90A controlled by ESC 24 by a MSVA 88. Where PTO loads 23 are hydraulic lifting units 9 and upper boom compensating assembly 17 it may be that wipers can be dispensed with because the vehicle is unlikely to be moving for a PTO application/load of that nature. Similarly a pneumatic central tire inflation system 90B is unlikely to be used while the vehicle is stationary, although unlike the suspension system pressure would not be dumped from the tires during PTO. On the other hand, if the pneumatic application 90 is an pneumatic tool 90C tool likely to be used by a workman from basket 5 the air driven tool may be left active. Various combinations of PTO loads 23 and pneumatic systems turned on and off in a coordinated manner with ePTO operation of the PTO loads may be conceived of.

Operator selection and deselection of PTO modes of operations is often provided on the transmission push button controller 72. Some PTO modes require for example that a vehicle be placed in park, which involves the transmission controller 42 in PTO operational modes. When the conditions for PTO operation are satisfied and the vehicle also enters electrical PTO mode, air leveling suspension operation is suspended. The air leveling suspension system will not again resume its normal mode of operation until such time as the ePTO mode of operation is deselected. Suspension of operation of leveling may include using valve 86 to equalize the pressure in the air springs/bags 56 with atmospheric pressure.

To implement selective suspension and activation of air leveling the suspension system through adjustment of air pressure in the air springs 56, a controller area network (CAN) communication strategy is implemented where the different CAN modules, including ESC 24, transmission controller 42, hybrid controller 48 and engine controller 46, communicate over a datalink environment to exercise control over various aspects of the electrical and mechanical systems of the hybrid mobile aerial lift truck 1, including the automatic air leveling suspension system represented in its mechanical components by MSVA 78 and air springs 56 and it control components by level sensing module 45 and suspension controller 54, and pneumatic clutch 52 for PTO application 22. Electrical PTO mode of operation minimizes operational time of the internal combustion engine 28 because the low and sometimes sporadic power demands of some PTO loads 23 make it highly inefficient to use the internal combustion engine 28 to support the PTO application. Electrical PTO mode of operation is commonly supported when the vehicle is stationary (e.g., park brake ON, vehicle speed near zero mph, transmission current gear neutral). Continued automatic adjustment of the vehicle's ride height and level while the vehicle was stationary would deplete the hybrid mobile aerial lift truck 1 compressed air tank 62 (which may represent primary and secondary tanks) states of charge (SOC). Doing so could compromise the ability to support engagement of the pneumatically actuated, mechanical PTO shifting/engagement mechanism (pneumatic clutch 52). Other vehicle operational configurations may indicate circumstances when other pneumatic elements may be disengaged during ePTO mode.

Upon the activation of the ePTO mode of operation, MSVA 78 operates to dump the air in air springs 56 of the air suspension system, and the flow of additional air to the air springs is interrupted, reducing air demand on the primary and, or secondary air tanks (compressed air tank 62). The air suspension system would not then resume its “normal” mode of operation until such time that the hybrid mobile aerial lift truck 1 was taken out of the ePTO mode of operation whereupon the air suspension system resumes its normal, automated mode of maintaining the vehicle's ride height and level. Compressed air demand beyond that stored in compressed air tank 62 may be satisfied by running the internal combustion engine 28 to drive the air compressor 60.

Similarly, MSVA 88 may be operated selectively to allow or limit operation of pneumatic application 90 during electrical mode PTO. This decision may depend upon the character of the PTO application 23 and the vehicle's situation. For example, most, but not all, PTO applications 23 will involve making a vehicle stationary. For a vehicle equipped with pneumatic windshield wipers there will likely by little need to operate the wipers during PTO and thus they may be disabled. A central tire inflation system can be treated like an air suspension system except that air pressure in the tires is not dumped upon entering ePTO mode. A pneumatic tool circuit may be useful to an operator during ePTO and allowed to continue operation.

Transmission controller and ESC 24 both operate as portals and/or translation devices between the various data links 68, 18, 74 and 64. Data links 68 and 74 may be proprietary/private and operate at substantially higher baud rates than does the public data link 18. Accordingly, buffering is provided for messages passed between data links. Additionally, a message may have to be reformatted, or a message on one link may require another type of message on the second link, e.g. a movement request over data link 74 may translate to a request for transmission engagement from ESC 24 to transmission controller 42. Data links 18, 68 and 74 are usually controller area network buses which conform to the SAE J1939 protocol.

Description here of a system in combination with an aerial lift unit 2 does not foreclose other applications which could include by way of example: outriggers; booms; roll-back decks; derricks; augers and the like.

What is claimed is:

1. A vehicle, comprising:
an internal combustion engine;
an electric traction motor which may be back driven to generate electricity;
a power take off application;
a pneumatic supply system including compressed air storage and a compressor connected for operation to the internal combustion engine;
pneumatic applications which may be selectively connected to receive air under pressure from the pneumatic supply system; and
a controller responsive to actuation of the power take off application supported by the electric traction motor for suspending supply of air under pressure to selected pneumatic components from the pneumatic supply system.

2. A vehicle as claimed in claim 1, further comprising:
a pneumatically actuated connector connected to the pneumatic supply system and operative to provide selective operation of the power take off application from the internal combustion engine or the electric fraction motor.

3. A vehicle as claimed in claim 2, further comprising:
the pneumatic application including an air suspension system including air springs;
the controller responsive to action of the power take off application being part of a leveling system for the air suspension system leveling system; and
the leveling system providing for suspending operation of the air suspension system and discharging the pneumatic components of the suspension system during power take off operation supported by the electric traction motor.

4. A vehicle as claimed in claim 3, further comprising:
pressure sensors for the pneumatic supply system; and
controllers responsive to the pressure sensors for engaging operation of the internal combustion engine for maintaining pressure in the pneumatic system.

5. A vehicle as claimed in claim 4, further comprising:
the power take off application including components affecting loading of the vehicle.

6. A vehicle as claimed in claim 5, further comprising:
a traction battery; and
means responsive to state of charge of the traction battery for controlling starting the internal combustion to back drive the electric traction motor for generation of electricity and stopping the internal combustion engine when the traction battery state of charge meets a minimum.

7. A vehicle comprising:
an electric traction motor;
an internal combustion engine;
a power take off application;
a pneumatic system including compressed air storage and a compressor connected for operation to the internal combustion engine;
pneumatic components which are connected to receive compressed air from the pneumatic system including a pneumatic coupling element for engaging the power take application to one of the internal combustion engine and the electric traction motor; and
a controller for suspending discharge of compressed air from the pneumatic system to selected pneumatic components in response to operation of the pneumatic coupling element and the electric traction motor to support the power take off application.

8. A vehicle as claimed in claim 7, further comprising:
the pneumatic components including elements of a self leveling suspension system.

9. A vehicle as claimed in claim 8, further comprising:
a controller responsive to operation of the power take off application by the electric traction motor for suspending operation of the self leveling suspension system including discharge of the pneumatic components of the self leveling suspension system.
